(19) United States
(12) Patent Application Publication
(10) Pub. No.: US 2010/0135560 A1
(43) Pub. Date: Jun. 3, 2010

(54) IMAGE PROCESSING METHOD

(75) Inventors: Karl Vincent Embleton, Macclesfield (GB); Geoffrey James Martin Parker, Cheshire (GB); Hamied Ahmad Haroon, Manchester Greater Manchester (GB)

Correspondence Address: MICHAEL BEST & FRIEDRICH LLP, 100 E WISCONSIN AVENUE, Suite 3300, MILWAUKEE, WI, 53202, US

(73) Assignee: THE UNIVERSITY OF MANCHESTER, Manchester (UK)

(21) Appl. No.: 12/598,585

(22) PCT Filed: May 1, 2008
(86) PCT No.: PCT/GB08/01533

§ 371 Date: Feb. 4, 2010

(30) Foreign Application Priority Data
May 4, 2007 (GB) 0708621.8

(51) Int. Cl. G06K 9/62

(52) U.S. Cl. 382/131; 382/128

(57) ABSTRACT

A method for generating data indicating a degree of anatomical connectivity for each of a plurality of image elements, each image element representing a part of a body to be imaged. The method comprises for each of a plurality of image elements, that image element and others of said plurality of image elements; for each of said plurality of image elements, generating data indicating a degree of connectivity of that image element, said degree of connectivity being based upon said plurality of generated data sets.

The present invention relates to an image processing method and more particularly to a method for generating data indicating a degree of connectivity for each of a plurality of image elements, each image element representing a part of a body to be imaged. The invention has particular, although not exclusive, applicability in imaging of the human nervous system and in imaging of the nervous system of non-human animals.

A wide variety of imaging techniques are known in the art. One such technique is magnetic resonance imaging which is based upon nuclear magnetic resonance and which generates images of a body (for example a human body) based upon water content at each of a plurality of volume elements in the body.

Nuclear magnetic resonance (NMR) involves applying a magnetic field that acts on the nuclei of atoms with fractional spin quantum numbers and thereby polarizes them. During measurements, radio-frequency pulses of given resonance energy are applied that flip the nuclear spins and disturb the orientation distribution. The nuclei then return (relax) to the initial state in a time dependent exponential fashion and thereby provide a signal that may be electronically processed into recordable data. When the signals are spatially differentiated and of sufficient level, the data can be used to generate images suitable for display on a display screen. For example, computing the signals generated by the protons of water molecules within organic tissues makes it possible to construct magnetic resonance images (MRI) allowing direct visualization of internal organs in living beings. NMR is therefore a powerful tool in diagnostics, medical treatment and surgery.

Magnetic resonance imaging may also be used to measure the extent and orientation of passive self-diffusion of water molecules in a body. In general terms (i.e. when in their pure liquid state and unhindered by physical barriers) water molecules will diffuse equally in all directions (a process also known as Brownian motion). However, within the human body, where coherently-arranged microstructural elements such as cell membranes exist, there is likely to be a preferred orientation of diffusion. Such a preferred orientation of diffusion can be detected using magnetic resonance imaging techniques. In organs where the preferred orientation of diffusion observed in each image voxel is the result of long-range (with respect to the imaging spatial resolution) structural elements (hereafter referred to as ‘biological pathways’) it is possible to generate images that represent those biological pathways. The general class of MRI methods used to detect water self-diffusion in the body is known as diffusion weighted imaging (DWI). A number of variants of this technique are known, such as diffusion tensor imaging, diffusion spectrum imaging, and q-space imaging.

Imaging techniques intended to generate images representing biological pathways have particular applicability in brain imaging. Here, the biological pathways are the structures that interconnect brain regions, or other areas of a central nervous system. At the microscopic scale these are the axons associated with neuronal tissue. Axons are grouped together (particularly but not exclusively in the white matter) to form axonal bundles that provide the macroscopic diffusion signal generally exploited in such techniques. It is possible to generate images of areas of high microstructural orientation coherence, which tend to be concentrated in the white matter within a brain (where they may be referred to as ‘fibre bundles’). Such white matter comprises fibre bundles which connect together various regions of grey matter within the brain. The grey matter makes up the brain's processing elements.

The orientational information concerning fibre bundle orientation that DWI provides may be exploited to analyse anatomical connectivity non-invasively via a process known as ‘tractography’ or ‘fibre tracking’. A number of methods have been developed to infer connection between brain regions. These methods fall into two broad groups: ‘deterministic’ approaches and ‘probabilistic’ approaches. Probabilistic methods have the general advantage of being able to estimate the confidence with which an anatomical connection between any image voxel within a brain and another can be established from the DWI data.

Many techniques used to generate images representing the biological pathways have difficulty in accurately generating images in which a plurality of pathways cross one another at some point within the image. This often occurs in brain imaging. In such cases, such techniques do not accurately generate images properly showing each of the pathways. An example of such a technique is a fractional anisotropy technique described in Pierpaoli, C. and P. J. Basser: “Toward a quantitative assessment of diffusion anisotropy” Magnetic Resonance in Medicine 36, pp 893-906.

One imaging technique is described in Parker, G. J. M and Alexander, D. C: “Probabilistic anatomical connectivity derived from the microscopic persistent angular structure of cerebral tissue”, Phil. Trans. R. Soc. B (2005) 360, pp 893-902. Here an image indicating connectivity between a particular starting point and other points within the body is generated and displayed. The described technique is based upon magnetic resonance imaging.

While many deterministic and probabilistic tractography techniques are effective, there is a general requirement to accurately locate or place starting points of interest. This can be very difficult if it is not known which areas of the brain are of interest, for example where it is not know where in the brain connections of interest exist. It is an object of embodiments of the present invention to obviate or mitigate at least some of the problems outlined above.

According to the present invention, there is provided, a method and apparatus for generating data indicating the degree of anatomical connectivity for each of a plurality of image elements. Each image element represents a part of a body to be imaged. The method comprises, for each of a plurality of image elements, generating a data set indicating connections between that image element and others of said plurality of image elements. For each of said plurality of image elements, data indicating a degree of connectivity of that image element is generated. The degree of connectivity is based upon said plurality of generated data sets.

By generating a data set indicating connections between each of a plurality of image elements and other image elements, and then processing all image elements based upon the generated data sets, data indicative of the overall degree of connectivity of a particular point within the body being imaged can be generated. Methods provided by embodiments of the invention therefore allow the overall connectivity of a particular point within the body being imaged to be compared to the overall connectivity of other points within the body being imaged.

Each point within the body being imaged may be represented by a voxel. That is, the image elements may be voxels.

In the specific example of the brain, embodiments of the present invention allow the degree of anatomical connectivity from each brain voxel to every other brain voxel to be expressed to form a map of the degree of anatomical connectivity of each location of the brain parenchyma. Again, the methods provided allow information indicating connectivity of a particular voxel relative to other voxels to be generated.

Each of the data sets may represent a linear connection between one of said image elements and a plurality of other image elements.

The method may further comprise, for each of said plurality of image elements, generating a plurality of data sets. Each of said plurality of data sets may be a data set indicating connections between that image element and others of said plurality of image elements.

Each image element may have associated data indicating a plurality of possible connections for that image element, and said plurality of data sets may be based upon said data. The associated data may be a probability density function indicating probabilities of said possible connections. That is, for a particular image element the associated data may indicate probabilities for each of a plurality of image elements to which the particular image element may be connected.

Generating data indicating a degree of connectivity of an image element may comprise determining a number of data sets in which said image element is included. The method may further comprise generating image data based upon said data indicating a degree of connectivity. Each image element may be rendered using a value based upon said data indicating a degree of connectivity. Each image element may be rendered using a value based upon said data indicating a degree of connectivity relative to other image elements.

The image elements may be defined using data obtained from a magnetic resonance imaging technique. Each of the image elements may be defined using data indicative of an orientation of diffusion within said body at a point represented by that image element.

The method may further comprise deriving said probability density functions for each of said image elements based upon data indicative of said orientation of diffusion.

The body may be a human or animal body or a part of a human or animal body. For example, the body may be a human or animal brain or a part of a human or animal brain.

The method may further comprise comparing said image data with reference data to generate data indicating characteristics of said body. The reference data may be indicative of a clinically normal state of said body, and the comparison may generate data indicating whether said body is in a normal or diseased state. In this way, data generated using the methods described above can be used to detect differences in connectivity between a plurality of different bodies, for example between a plurality of different patients.

The method may further comprise comparing said image data with further data generated from said body at an earlier time. That is, first image data may be generated from a body at a first time and second image data may be generated from the same body at a second time. The first and second image data may be compared to generate data indicating a change in the state of the body. Such data may indicate development or degeneration of said body.

The present invention further provides a method and apparatus for generating data indicating likelihood of diffusion in each of a plurality of directions at an image element of an image representing a part of a body being imaged. The method comprises: generating a plurality of estimates of each of said plurality of directions of diffusion from said image data; and generating said data indicating likelihood of diffusion in each of said plurality of directions based upon said plurality of estimates.

The method may further comprise processing said image data by application of a Funk-Radon transform to generate transformed image data. The plurality of estimates of each of said plurality of directions of diffusion may be generated from said transformed image data.

Generating one of said plurality of estimates for each of said plurality of directions of diffusion may comprise sampling an orientation distribution function at each of a plurality of points. Each of said plurality of points may be located on the surface of a sphere.

Some of said plurality of estimates for each of said plurality of directions may be determined by generating a set comprising a plurality of points, processing said set of points with reference to a further set of points to generate difference data, and generating a new set of points based upon said difference data.

All aspects of the present invention can be implemented by way of methods and apparatus. Such apparatus can include suitably programmed computers as well as bespoke hardware. Aspects of the invention can be implemented by way of suitable computer programs, which can be embodied on both tangible and intangible carrier media.

Embodiments of the present invention will now be described, by way of example, with reference to the accompanying drawings in which:

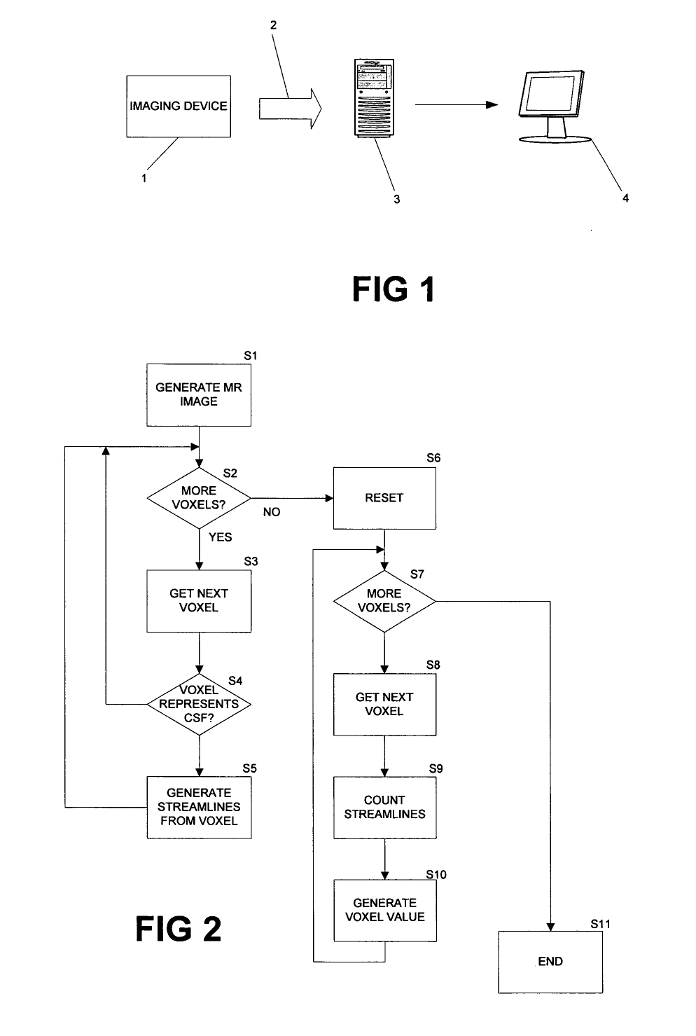

FIG. 1 is a schematic illustration of apparatus used to implement an embodiment of the present invention;

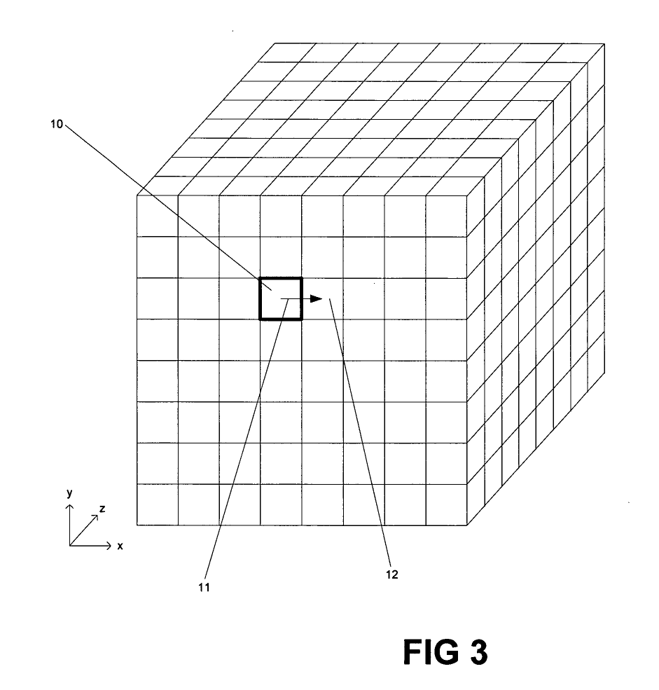

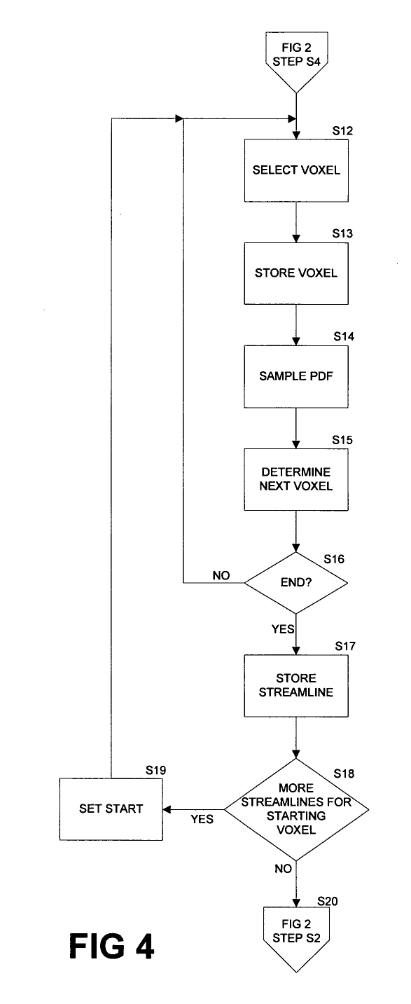

FIG. 2 is a flow chart showing processing carried out in an embodiment of the invention at a high level;

FIG. 3 is a schematic illustration of a subset of voxels;

FIG. 4 is a flow chart showing how streamlines are generated representing connectivities between the voxels of FIG. 3;

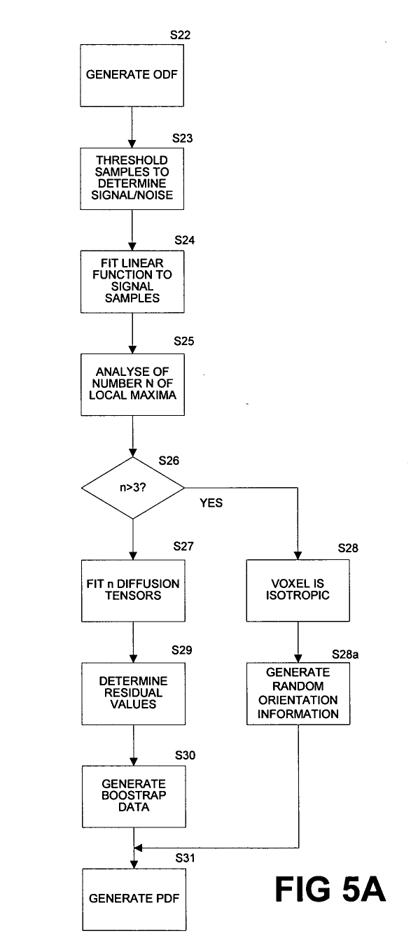

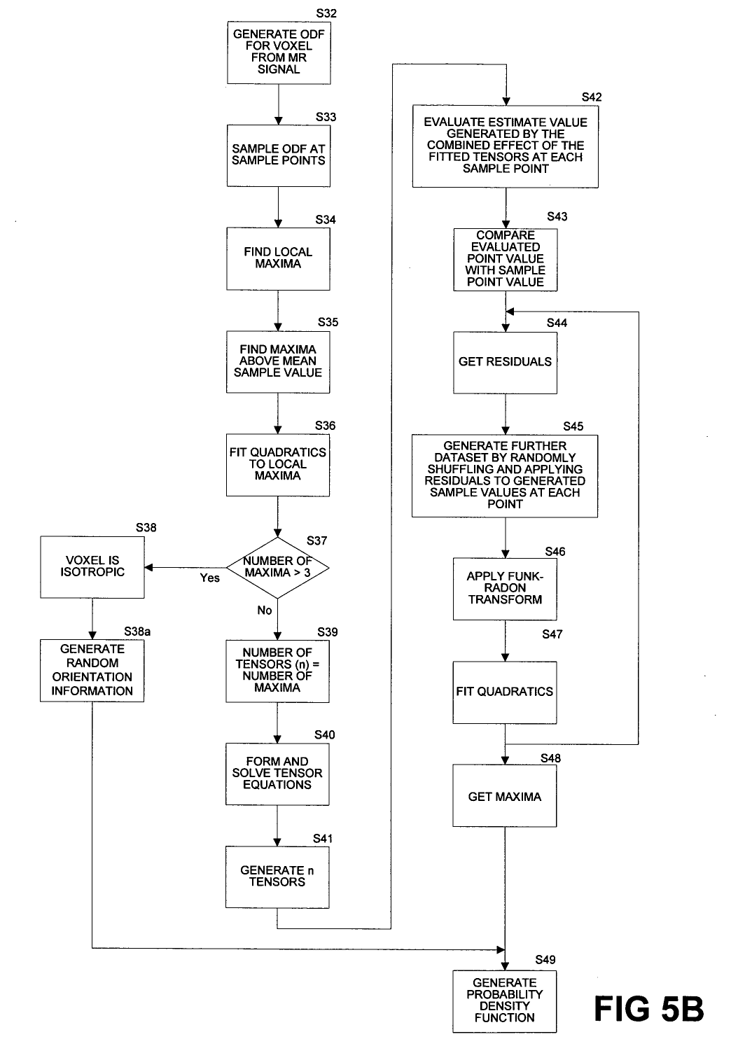

FIGS. 5A and 5B are flow charts showing a process for generating a probability density function for a voxel;

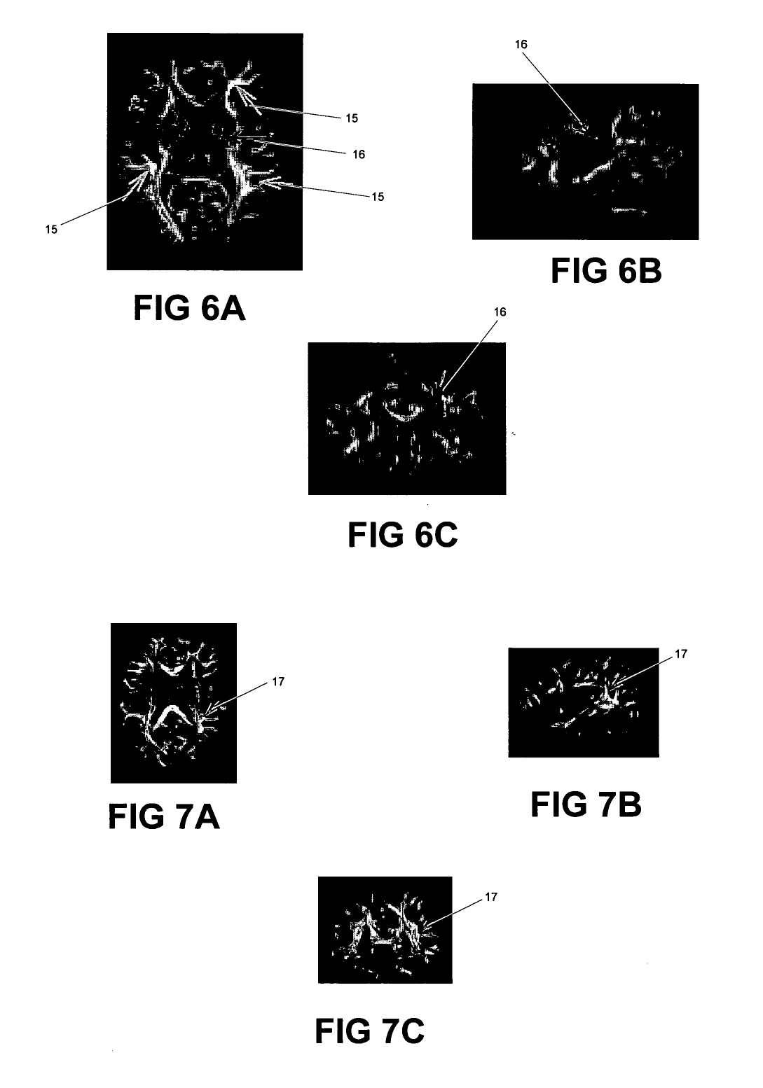

FIGS. 6A to 6C are images obtained using techniques in accordance with an embodiment of the invention;

FIGS. 7A to 7C are further images obtained using techniques in accordance with an embodiment of the invention;

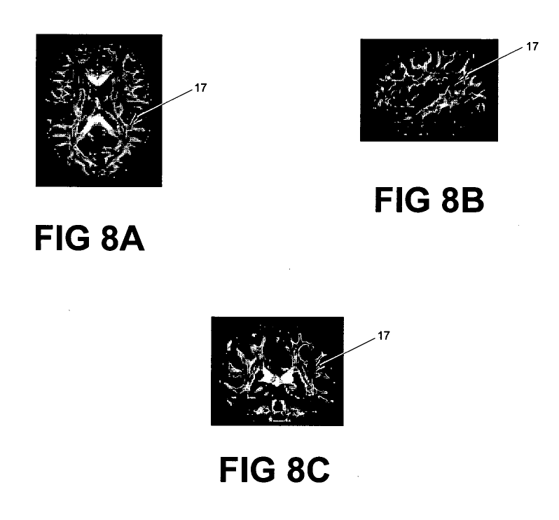

FIGS. 8A to 8C are images obtained using a prior art imaging methodology;

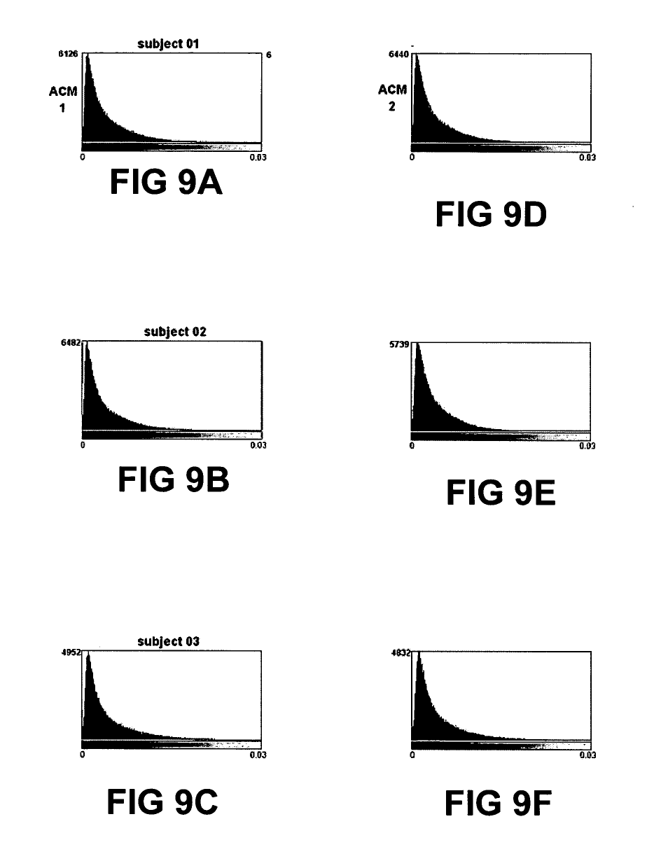

FIGS. 9A to 9F are histograms showing voxel values taken from images obtained using techniques in accordance with an embodiment of the invention; and

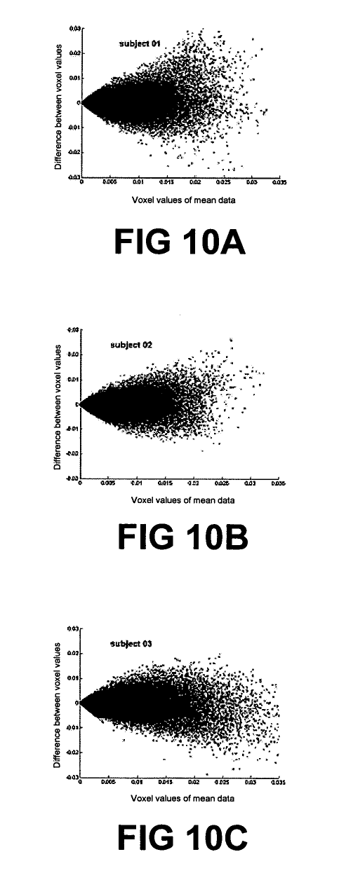

FIGS. 10A to 10C are Bland-Altman plots indicating reproducibility of voxel values taken from images obtained using techniques in accordance with an embodiment of the invention, when such techniques are repeated.

Referring first to FIG. 1, it can be seen that an imaging device 1 outputs image data 2. The image data 2 is input to a PC 3 where it is further processed before being displayed on a display device 4. The PC 3 is configured to carry out various processing which is described in further detail below and which is intended to allow the generation of image data which is suitable for a particular purpose and which can be displayed on the display device 4.

In some embodiments of the invention image data representing an image of a human or animal brain is processed. In such embodiments the imaging device can take the form of a magnetic resonance imaging device, as is known in the art. In general terms such imaging devices generate image data based upon water content of a body which is imaged. Using a class of MRI methods known as diffusion weighted imaging DWI, data indicating the orientation of diffusion of water at a particular point of the body can be generated. For example, while in general terms water will diffuse equally in each possible direction, in a biological context, such as within the human brain, diffusion will be anisotropic, that is to say not equal in each possible direction. Such anisotropic diffusion can be caused by, for example, aligned microstructural elements within the body being imaged. In such a case magnetic resonance imaging techniques are able to determine tone or more dominant orientations of diffusion within an imaging voxel or the distribution of diffusion orientations within an imaging voxel, and thereby determine useful information relating to microstructural elements within a body being imaged.

Magnetic resonance imaging data generated by the imaging device 1 is input to the PC 3 where it is processed to generate useful information relating to characteristics of the body being imaged. This processing is shown at a high level in FIG. 2. In general terms the processing is intended to define the degree of anatomical interconnection between voxels or regions of a brain. In general terms, higher levels of interconnection are expected in the white matter of the brain than in the grey matter of the brain. White matter is essentially parts of the brain which connect processing centres (within grey matter) together so as to allow communication.

Referring to FIG. 2, it can be seen that at step S1 magnetic resonance image data is generated. Such data provides three-dimensional image data defined by a plurality of voxels. A voxel is a volume element, which has a similar function in three-dimensional imaging to that of a pixel in two-dimensional imaging.

Each voxel of the data generated at step S1 is processed in turn. At step S2 a check is carried out to determine whether further voxels remain to be processed. If the check of step S2 is satisfied, processing passes to step S3 where a voxel is selected for processing. At step S4 a check is carried to determine whether the voxel obtained at step S3 represents part of the cerebro-spinal fluid (CSF) within the brain. This processing can be carried out by a thresholding operation which is such that voxels having a value above or below the threshold (depending upon the imaging methodology) are determined to represent part of the cerebro-spinal fluid. Voxels that are determined to represent part of the cerebro-spinal fluid are processed no further, and processing therefore returns to step S2 where a check is carried out to determine whether further voxels remain to be processed.

Where a voxel is determined not to represent part of the cerebro-spinal fluid at step S4, processing continues at step S5. Here a plurality of streamlines are generated representing connections between the currently processed voxel and other voxels within the image data generated at step S1. The generation of streamlines is discussed in further detail below. It should however be noted that each streamline essentially represents a linear pathway between a currently processed voxel and a plurality of other voxels.

Having generated a plurality of streamlines at step S5, processing returns to step S2 and continues in the manner described above. It will be appreciated that iterations of steps S2 to S5 will generate a plurality of streamlines for each voxel of the image data generated at step S1 which is determined (at step S4) not to represent part of the cerebro-spinal fluid.

When the check of step S2 indicates that no further voxels remain to be processed, processing passes from step S2 to step S6. At step S6 a reset operation is carried out on a voxel counter, before processing passes to step S7 where a check is carried out to determine whether further voxels remain to be processed. If further voxels remain to processed, processing continues at step S8 where a voxel is selected for processing. At step S9 a check is carried out to determine how many of the generated streamlines pass through the voxel selected at step S8. A value for the voxel being processed is then generated at step S10. Calculation of a value for the voxel being processed can be carried out according to equation (1):

$$Voxel Value = \frac{N}{M} \qquad ( 1 )$$

### Where:

N is the total number of streamlines, generated from each voxel, which pass through the voxel; and
M is the total number of generated streamlines.

It can be seen that by generating voxel values in accordance with equation (1) voxels through which a large number of streamlines pass have a higher value than voxels through which fewer streamlines pass. Using equation 1 it is therefore possible to produce an image in which voxel intensity (i.e. voxel value) is indicative of a number of streamlines passing through a particular voxel. That is, an image in which voxel intensity is indicative of the overall connectivity of a voxel can be generated. Processing passes from step S10 to step S7 where a check is carried out to determine whether further voxels remain to be processed. If this is case, processing continues at step S8. Otherwise, processing terminates at step S11.

In an alternative embodiment, instead of applying processing as described with reference to steps S6 to S10 of FIG. 2, the number of streamlines which pass through the voxel currently being considered may be determined by maintaining a running count of the number of times each voxel is intersected by a streamline during the processing of steps S2 to S5 above.

Referring back to step S5 of FIG. 2, it can be seen that a plurality of streamlines for each voxel are generated. This processing is now described in further detail with reference to FIGS. 3 and 4, where FIG. 3 is a schematic illustration of a relatively small number of adjacent voxels, and FIG. 4 is a flow chart of processing carried out at step S5 of FIG. 2.

Referring to FIG. 3 it can be seen that a cuboid defined by a plurality of voxels is illustrated. For each voxel which does not represent cerebro-spinal fluid, a plurality of streamlines are generated. Each voxel in the cuboid of FIG. 3 has an associated probability density function (PDF). The probability density function of a particular voxel represents the probability of diffusion in a variety of orientations in a part of the body represented by the voxel. The probability density function is generated using methods which are described in further detail below.

The number of streamlines generated starting from each voxel which does not represent cerebro-spinal fluid can be determined by requirements of the application for which image data is to be generated. It will be appreciated that, in general terms, a greater number of streamlines will provide higher quality data at a higher computational cost. In one implementation ten streamlines are generated for each voxel.

Referring to FIG. 4 processing carried out to generate streamlines is described. At step S12 a voxel to be processed is selected, and data indicating the selected voxel is stored at step S13. The probability density function of the selected voxel is sampled at step S14 using a Monte-Carlo technique to provide an indication of diffusion direction at the selected voxel. This direction determines a next point in the volume of voxels which is to be processed. That is, referring to FIG. 3, sampling the probability density function of a voxel 10 may generate direction data represented by the vector (1,0,0) as indicated by an arrow 11. In such a case a voxel 12 is selected for processing at step S15.

The length of a vector selected at a particular voxel can be chosen in any convenient way. In general, smaller vector lengths (or ‘step sizes’) allow for more accurate imaging. When the length of the vector does not represent a step exactly from the centre of one voxel to a neighbour, a spatial data interpolation technique can be employed. Any suitable interpolation technique may be suitably employed. In a currently preferred embodiment of the invention, a trilinear interpolation technique is used. Such a technique is described in Parker, G. J. M., H. A. Haroon, et al.: “A framework for a streamline-based probabilistic index of connectivity (PICo) using a structural interpretation of MRI diffusion measurements” Journal of Magnetic Resonance Imaging 18, pp 242-254, the contents of which is herein incorporated by reference thereto.

In alternative embodiments of the invention, other interpolation methods are used. Such methods include ‘nearest neighbour’ interpolation as described in Mori, S., B. J. Crain, et al.: “Three-dimensional tracking of axonal projections in the brain by magnetic resonance imaging.” Annals of Neurology 45, pp 265-269; trilinear weighted sampling of the neighbourhood PDFs as described in Behrens, T. E. J., M. W. Woolrich, et al.: “Characterization and propagation of uncertainty in diffusion-weighted MR imaging” Magnetic Resonance in Medicine 50(5), pp 1077-1088; and Runge-Kutta integration as described in Basser, P. J., S. Pajevic, et al.: “In vivo fiber tractography using DT-MRI data” Magnetic Resonance in Medicine 44, pp 625-632.

In a currently preferred embodiment of the invention, each streamline is terminates when it encounters a voxel representing cerebro-spinal fluid. Voxels representing cerebro-spinal fluid can be detected in the manner described above. Other possibilities for streamline termination include terminating a streamline when curvature is beyond a user-defined threshold, terminating a streamline when the diffusion anisotropy within the voxel being traversed by a streamline is below a user-defined threshold, and terminating a streamline when the streamline exceeds a predetermined maximum length.

At step S16 a check is carried out to determine whether the processed streamline violates the chosen termination criteria. If this is not the case, processing continues at step S12 where the voxel determined at step S15 is selected for processing.

If the check of step S16 determines that the currently generated streamline does not violate the chosen termination criteria, processing continues at step S17 where data indicative of the streamline is stored. Processing passes from step S17 to step S18 where a check is carried out to determine whether further streamlines originating from a particular voxel (that voxel having been determined by step S3 of FIG. 2) are to be generated. If this is the case, processing passes from step S18 to step S19 where the voxel determined at step S3 of FIG. 2 is again selected, before processing continues in the manner described above at step S12.

When the check of step S18 determines that the predetermined number of streamlines originating at a particular voxel have been generated, processing passes from step S18 to step S20, from where processing returns to step S2 of FIG. 2.

In the preceding description it has been explained that at each voxel a direction for a streamline which is being generated is determined by sampling of the probability density function using a Monte-Carlo technique. By repeated application of the method described above with reference to FIG. 4 (i.e. by generating a plurality of streamlines), it will be appreciated that streamlines will indicate connectivities representative of the probability density functions associated with the voxels.

The generation of streamlines using probability density functions is described in Parker, G. J. M and Alexander, D. C: “Probabilistic anatomical connectivity derived from the microscopic persistent angular structure of cerebral tissue”, Phil. Trans. R. Soc. B (2005) 360, pp 893-902, the contents of which are herein incorporated by reference thereto.

In alternative embodiments of the invention, alternative methods for the generation of streamlines using probability density functions are used. Examples can be found in Behrens, T. E. J., M. W. Woolrich, et al.: “Characterization and propagation of uncertainty in diffusion-weighted MR imaging”, Magnetic Resonance in Medicine 50(5), pp 1077-1088; Parker, G. J. M. and D. C. Alexander: “Probabilistic Monte Carlo based mapping of cerebral connections utilising whole-brain crossing fibre information”, Lecture Notes in Computer Science 2732, pp 684-695; Parker, G. J. M., H. A. Haroon, et al.: “A framework for a streamline-based probabilistic index of connectivity (PICo) using a structural interpretation of MRI diffusion measurements” Journal of Magnetic Resonance Imaging 18, pp 242-254; Hosey, T., G. Williams, et al.: “Inference of multiple fiber orientations in high angular resolution diffusion imaging” Magnetic Resonance in Medicine 54, pp 1480-1489; and Parker, G. J. M. and D. C. Alexander: “Probabilistic anatomical connectivity derived from the microscopic persistent angular structure of cerebral tissue” Philosophical Transactions of the Royal Society Series B 360, pp 893-902. Each of the referenced publications is incorporated herein by reference.

Alternative methods can be used for the generation of streamlines in embodiments of the invention. Examples of such methods are described in Behrens, T. E. J., M. W. Woolrich, et al.: “Characterization and propagation of uncertainty in diffusion-weighted MR imaging” Magnetic Resonance in Medicine 50(5), pp 1077-1088; Parker, G. J. M. and D. C. Alexander: “Probabilistic Monte Carlo based mapping of cerebral connections utilising whole-brain crossing fibre information” Lecture Notes in Computer Science 2732, pp 684-695; Parker, G. J. M., H. A. Haroon, et al.: “A framework for a streamline-based probabilistic index of connectivity (PICo) using a structural interpretation of MRI diffusion measurements” Journal of Magnetic Resonance Imaging 18, pp 242-254; and Hosey, T., G. Williams, et al.: “Inference of multiple fiber orientations in high angular resolution diffusion imaging” Magnetic Resonance in Medicine 54, pp 1480-1489.

The methods described above are not limited to using streamline methods for performing probabilistic tractography. That is, probabilistic tractography techniques can be applied in other ways. Alternatives include, for example, particle diffusion or particle jump methods, as described in Batchelor, P. G., D. L. G. Hill, et al.: “Study of connectivity in the brain using the full diffusion tensor from MRI” Proceedings of Information Processing in Medical Imaging IPMI'01, Davis, California, Springer-Verlag and Koch, M., V. Glauche, et al.: “Estimation of anatomical connectivity from diffusion tensor data” Neuroimage 13(6): S176-S176; and Koch, M. A., D. G. Norris, et al.: “An investigation of functional and anatomical connectivity using magnetic resonance imaging” Neuroimage 16, pp 241-250. Alternatively, front evolution methods of the type described in Parker, G. J. M., C. A. M. Wheeler-Kingshott, et al.: “Estimating distributed anatomical brain connectivity using fast marching methods and diffusion tensor imaging” IEEE Transactions on Medical Imaging 21(5), pp 505-512; and Tournier, J.-D., F. Calamante, et al.: “Diffusion-weighted magnetic resonance imaging fibre tracking using a front evolution algorithm” NeuroImage 20, pp 276-288.

The processing described above is based upon a probability density function associated with each voxel. The generation of a probability density function for each voxel is now described in further detail. A process for generating a probability density function for a particular voxel is now described with reference to FIG. 5A, and subsequently in further detail with reference to FIG. 5B. In a preferred embodiment, diffusion orientation data for each voxel is generated by applying a Funk-Radon transform to Magnetic Resonance data as described in Tuch, David S.: “Q-Ball Imaging”, Magnetic Resonance in Medicine (2004) 52, pp 1358-1372, the contents of which are herein incorporated by reference thereto.

A diffusion orientation distribution function (ODF) is generated for each voxel from the magnetic resonance data for that voxel at step S22 by application of the Funk-Radon transform as indicated above. The ODF is defined on the surface of a unit sphere centred at the centre of the voxel. In a preferred embodiment of the invention, sample values of the ODF are generated for each of a series of evenly distributed points on the unit sphere. In a preferred embodiment, the number of points is 642 and the configuration of the points on the surface of the sphere is given by the vertices of a three-fold tessellated icosahedron. Each sample value indicates measured diffusion information for the voxel along an axis defined by the path through the origin of the unit sphere and the point on the surface of the sphere denoted by the sample value.

At step 23, the sampled values are analysed in order to determine whether they are to be considered noise. In a preferred embodiment, the mean of the sampled values is calculated. Sampled values lower than the mean are considered to be noise samples, while sample values greater than the mean are considered to be signal samples, representative of diffusion directions for the voxel.

In steps S24 to S28, the sampled values are analysed in order to determine whether or not the voxel is anisotropic. In a preferred embodiment, a subset of the signal samples that have higher signal values than each of their immediate neighbours on the sphere (this can optionally be extended to define an arbitrarily large local neighbourhood if desired) are identified as local maxima and a linear function, for example a 2D quadratic function, is fitted to the subset of the signal samples in one hemisphere of the unit sphere for each voxel to find possible orientational diffusion maxima at step S24. The function is then analysed to determine the number of local maxima at step S25. If the number of local maxima is greater than a predefined threshold at step S26, the voxel is considered to be isotropic (i.e. to have no particular direction of diffusion) at step S28 and is associated with a random selection of orientations at step S28a. In a preferred embodiment, the threshold is 3.

If a voxel is considered anisotropic based upon the check of step S26, at step S27, the number and location of maxima in the signal values of the ODF for the voxel are used to determine the number of diffusion tensors for the application of a standard tensor mixture model as described in Tuch, D. S., T. G. Reese, et al.: “High angular resolution diffusion imaging reveals intravoxel white matter fiber heterogeneity” Magnetic Resonance in Medicine 48, pp 577-582; and Parker, G. J. M. and D. C. Alexander: “Probabilistic Monte Carlo based mapping of cerebral connections utilising whole-brain crossing fibre information” Lecture Notes in Computer Science 2732, pp 684-695. The tensor mixture model is then fitted to the magnetic resonance data for the voxel using a standard model fitting procedure such as Levenberg-Marquardt or simplex minimisation. The fitted tensor mixture model is used to generate a set of estimated values for the ODF sample values in the unit sphere. The difference between each estimated value and the sampled value for the same point on the unit sphere are recorded as residual values at step S29.

At step S30, a plurality of new datasets are generated based on the estimated values of the ODF and the residual values. First, a new dataset is generated by adding together each estimated value and a randomly selected residual value, and using the result as a new sampled value for the point on the unit sphere represented by the predicted values. The process is repeated in order to generate the plurality of data sets. This procedure is an implementation of a statistical technique known as ‘model-based bootstrapping’ or ‘wild bootstrapping’.

At step S31, new estimates are made for the number and orientation of diffusion directions by the process of applying the Funk-Radon transform to the new data set and then by fitting a 2D quadratic function and finding local maxima, as described above in steps S22 to S25. When all of the data sets have been processed, the resulting estimates represent a probability density function for the voxel.

Having described the generation of a probability density function with reference to FIG. 5A, the process is described in more detail with reference to FIG. 5B. Processing is described with reference to a single voxel. It will however be appreciated that analogous processing is carried out for each voxel in turn.

At step S32 an ODF is generated from magnetic resonance data. At step S33 the generated ODF is sampled at a predetermined number of points (642 in the preferred embodiment as indicated above). Local maxima of the sampled points are determined in a convenient manner at step S34.

At step S35, the determined maxima are compared with a mean value for the sampled points. At step S36 maxima determined to have values above the mean are processed to fit a 2D quadratic function to each such maxima and its surrounding points. That is, each maxima having a value greater than the mean has an associated 2D quadratic function.

At step S37 the number of maxima having associated 2D quadratic functions is determined. If this number of maxima is greater than a predetermined limit, the voxel is determined at step S38 to be isotropic and random orientation information is associated with the voxel at step S38a. The PDF for this voxel is based upon the random orientation information. The predetermined limit can conveniently be three. If the number of maxima having associated 2D quadratic functions is not greater than the predetermined limit, processing passes to step S39 where a parameter n indicating a number of tensors to be generated is set to be equal to the determined number of maxima having associated 2D quadratic functions. n tensors are then generated at steps S40 and S41 as is now described.

Equation (2) is formed at step S40, and tensors are generated based upon the magnetic resonance data:

$$S ( {r}^{i} ) = {S}_{0} \cdot {\sum }_{n = 1}^{N} {f}_{n} \cdot exp ( - b \cdot [ \begin{matrix}\begin{matrix}{r}_{1}^{i} {r}_{1}^{i} {D}_{1 , 1}^{n} + 2 {r}_{2}^{i} {r}_{1}^{i} {D}_{2 , 1}^{n} + \\ 2 {r}_{3}^{i} {r}_{1}^{i} {D}_{3 , 1}^{n} + {r}_{2}^{i} {r}_{2}^{i} {D}_{2 , 2}^{n} +\end{matrix} \\ 2 {r}_{2}^{i} {r}_{3}^{i} {D}_{2 , 3}^{n} + {r}_{3}^{i} {r}_{3}^{i} {D}_{3 , 3}^{n}\end{matrix} ] ) \qquad ( 2 )$$

where:

S(rⁱ) is the spin-echo diffusion-weighted signal obtained from the magnetric resonance data and measured along the gradient sampling direction rⁱ={r₁ⁱ, r₂ⁱ, r₃ⁱ}^{T}, where i takes values from 1 to 61 in a preferred embodiment of the invention;

b=γ²·δ²·G₀²·(Δ−(δ/3)),

where:
γ is the gyromagnetic ratio for the proton;
G₀ is the maximum amplitude of the applied diffusion sensitisation gradients; and
δ is the duration of the applied diffusion sensitisation gradients, and Δ is the time interval between these gradients;
S₀ is a signal measured without any diffusion sensitisation (i.e. with b=0);
N is the number of fiber orientations estimated to exist in the voxel of interest, that is the number of tensors which are to be modelled; and
ƒₙ is the fractional contribution of each diffusion tensor Dⁿ to S(rⁱ), such that

$${\sum }_{n = 1}^{N} {f}_{n} = 1.$$

Each Dⁿ is given by equation (3):

$${\underline{D}}^{n} = [ \begin{matrix}{D}_{1 , 1}^{n} & {D}_{1 , 2}^{n} & {D}_{1 , 3}^{n} \\ {D}_{2 , 1}^{n} & {D}_{2 , 2}^{n} & {D}_{2 , 3}^{n} \\ {D}_{3 , 1}^{n} & {D}_{3 , 2}^{n} & {D}_{3 , 3}^{n}\end{matrix} ] \qquad ( 3 )$$

where D_{2,1}ⁿ=D_{1,2}ⁿ, D_{3,1}ⁿ=D_{1,3}ⁿ, D_{2,3}ⁿ=D_{3,2}ⁿ, as Dⁿ is a symmetric positive definite tensor.

Equation (2) will be applied for each gradient sampling direction (61 in preferred embodiments), so as to produce a system of nonlinear equations. In general terms, it is to be noted that all parameters save for Dⁿ and ƒ(n) are known, such that the generated equations can be used at step S41 to generate the desired tensors. Minimisation of the sum of squared differences between the acquired diffusion-weighted signal in the directions rⁱ and the predicted S(rⁱ) will give the tensor elements of Dⁿ.

For each of the points at which the original ODF was sampled at step S33, a value is generated based upon the generated tensors Dⁿ at step S42. In this way, the generated tensors provide a further set of points containing a number of points equal to that at which the ODF was sampled at step S33.

At step S43 the set of points generated at step S42 is processed together with the set of points sampled at step S33. This generates a set of error values at step S44. The generated error values are then applied to the set of points generated at step S42 so as to generate a further set of points at step S45. At step S46 a Funk-Radon transform is applied to the generated set of points, and at step S47 respective 2D quadratic equations are fitted to all maxima having a value above the mean value, as described above.

The processing of steps S44 to S47 is repeated a plurality of times so as to generate a plurality of sets of quadratic equations. The maximum of each 2D quadratic equation is taken at step S48 to represent an estimate of diffusion orientation. At step S49, processing is carried out to generate a probability density function from the generated quadratic equations.

The processing described above has been used to generate image data with good results. Magnetic resonance image data was obtained using a high angular resolution diffusion weighted imaging technique. This imaging used a dual direction k-space filling distortion corrected protocol as described in Embleton K. V., Lambon Ralph M. A. and Parker G. J.: “A combined distortion corrected protocol for Diffusion Weighted Tractography and fMRI”, ISMRM, 1070, 2006, the contents of which is incorporated herein by reference thereto. Imaging was carried out using a pulsed gradient spin echo EPI sequence on a 3T Philips Achieva scanner having an eight element SENSE head coil with a SENSE factor of 2.5. Phase encoding was in the left-right orientation. Imaging parameters were:

| | | |
|---|---|---|
| Echo time | TE | 54 ms |
| Repetition time | TR | 11884 ms |
| Gradient | G | 62 mTm⁻¹ |
| Matrix size | | 112 × 112 |
| Reconstructed resolution | | 1.875 mm |
| Slice thickness | | 2.1 mm |
| Number of slices | | 60 |
| Diffusion sensitation directions | | 61 |
| Sensitation | b | 1200 smm⁻² |
| Diffusion sensitisation gradient duration | δ | 13.5 ms |
| Diffusion sensitisation gradient spacing | Δ | 28.5 ms |

Images were obtained as described above, and processed so as to generate a probability density function for each voxel, and thereafter to generate a plurality of streamlines, as described above. Images obtained using these methods are shown in FIGS. 6A to 6C.

FIGS. 6A to 6C show a range of anatomical connectivity information which is available using the techniques described above. High intensity voxel values can be seen in tracts 15 connecting regions involved in language processing such as Wernicke's areas and left Broca's area. Much lower intensity voxel values are seen in the cortciospinal tracts (CSTs) 16. This is consistent with the extensive inter-regional connections within the language system and the relatively small number of connections from the motor regions to regions other than the brainstem, spinal cord, and thalamus.

FIGS. 7A to 7C show three further images obtained using the techniques described above. FIGS. 8A to 8C show images generated using a known fractional anisotropy technique, which is generally assumed to identify white matter tracts (i.e. connecting pathways) within the brain. A fractional anisotropy technique is described in Pierpaoli, C. and P. J. Basser: “Toward a quantitative assessment of diffusion anisotropy” Magnetic Resonance in Medicine 36, pp 893-906. It can be seen that areas 17 of high connectivity are not shown when the fractional anisotropy technique is used but are properly shown when the techniques described above are employed.

The techniques described above are advantageous in a number of respects. Specifically, given that the probabilistic tractography technique used to generate streamlines is initiated from each voxel (save for voxels representing cerebro-spinal fluid) there is no need to accurately locate a voxel from which the probabilistic tractography technique is to be initiated. This is a marked advantage over some prior art techniques which are intended to determine the connectivity of a particular voxel to other voxels and which therefore require accurate identification of the particular voxel.

It should be noted that the techniques described above allow connectivity between all brain regions to be effectively imaged, including regions representing white matter and regions representing grey matter.

The techniques described above provide information concerning the degree of cerebral anatomical interconnection to/from a given voxel position. As indicated above, relatively low intensity values can be seen in the CST. This is because although voxels representing the CST have high connectivity within the coherent structure of the corona radiata, they have low connectivity to the majority of other brain regions. Fractional anisotropy techniques do not provide information about how ‘well-connected’ voxels are. Conversely, the high, and lateralised, intensity values obtained in regions connecting language areas indicate the specificity of the method described above in distinguishing different degrees of ‘connectedness’.

The techniques described above can be used for brain imaging in a variety of contexts. Typically, images generated using the techniques described above are compared with reference images to determine whether the imaged brain shows any abnormalities. The reference images may be generated from measurements taken from a plurality of subjects. As such, comparisons of this type are referred to herein as inter-subject comparisons. Images indicative of particular abnormalities may additionally or alternatively be stored and compared with obtained images. The techniques described have potential in studying pathologies such as, but not limited to, semantic dementia, MS, stroke, and schizophrenia, Alzheimer's disease, epilepsy and any pathology that may affect the degree of connection between brain regions.

The techniques described above can be used to compare a plurality of images taken from a single subject (intra-subject comparisons). For example a plurality of images can be generated from data taken from a single patient at different points in time over a period of time. The generated images can be compared with one another to detect any changes in connectivity within the subject. For example, effects caused by degenerative conditions can be detected in this way, as can effects caused by developmental problems.

It will be appreciated that intra-subject and inter-subject comparisons of the type described above require a degree of reproducibility in the measurements taken both from a single subject and from a number of different subjects. Reproducibility of the processing used in image generation is also required. Tests have shown that embodiments of the invention do indeed provide such reproducibility.

An investigation of the extent of differences between images generated from different sets of measurements taken from a single subject allow theoretical calculations on the sensitivity and hence group size required to detect differences between subject groups to be carried out. Differences between images generated from measurements taken from a single subject could be due to a combination of factors including measurement differences (including scanner noise, subject movements and subject positioning), differences in PDF generation, the probabilistic nature of the generation of streamlines and genuine physiological differences.

Reproducibility of the entire process from diffusion weighted MRI measurements to image generation as described above was assessed using the data from a plurality of subjects undergoing repeat scanning.

FIGS. 9A to 9F are histograms showing values of voxels in image data generated by the processing described above. FIGS. 9A and 9D show voxel values of two data sets generated from a first subject, FIGS. 9B and 9E show voxel values of two data sets generated from a second subject, while FIGS. 9C and 9F show voxel values of two data sets generated from a third subject.

These histograms of FIGS. 9A to 9F show a virtually identical shape both within and between subjects. The only substantial difference in the histograms of FIGS. 9A to 9F is a reduction on the Y axis in the histograms relating to the third subject as compared with the first and second subjects due to a smaller brain volume in the third subject.

Bland-Altman plots of the difference between intra-subject data are shown in FIGS. 10A to 10C, where FIG. 10A shows data related to the first subject, FIG. 10B shows data related to the second subject and FIG. 10C shows data related to the third subject. The use of Bland-Altman plots are described in Bland, M: “An Introduction to Medical Statistics”, Oxford University Press, 1995. p272, which is incorporated herein by reference.

The Bland-Altman plots cluster around zero indicating that no overall bias was present between the intra-subject plots.

Measurements of intra-subject differences as a percentage of mean voxel value are shown in Table 1.

TABLE 1

| | difference as % of mean | | difference as % of mean | |
|---|---|---|---|---|
| | Methods described herein | | Fractional Anisotropy | |
| | mean | SD | mean | SD |
| subject | voxel level | voxel level | voxel level | voxel level |
| 01 | 32.852 | 24.241 | 15.088 | 14.257 |
| 02 | 31.354 | 23.444 | 17.324 | 15.648 |
| 03 | 29.577 | 22.407 | 13.916 | 15.326 |
| mean | 31.261 | 23.364 | 15.443 | 15.077 |

The values shown in Table 1 are the mean and standard-deviation (SD) of the differences, at the level of the individual voxel, for all voxels common to both data sets after registering to standard space. The equivalent statistics for fractional anisotropy data are also given for comparison.

The analysis set out above leads the present inventors to conclude that the techniques described herein can effectively be used to generate image data which is suitable for inter-subject and intra-subject comparison.

It has been described above with reference to FIG. 1 that image data 2 is generated by the imaging device 1 and passed to the PC 3 for further processing. It will be appreciated that in alternative embodiments of the present invention, the PC 3 may be replaced by a bespoke device configured to implement the processing described above. Alternatively, the imaging device 1 may itself be configured to carry out the processing described above. Similarly, the display screen 4 may be incorporated into the imaging device 1.

Embodiments of the present invention have been described above in the context of brain imaging. It should be noted that embodiments of the invention are not restricted to brain imaging but are instead widely applicable, and could be applied to the imaging of a plurality of different objects. Specifically, in a biomedical context, the techniques can be used to generate images of any part of the central nervous system including a subject's spinal cord. Imaging of a subject's heart could also be carried out.

Although preferred embodiments of the invention generate diffusion orientation data for each voxel as described above using the Q-ball imaging method, other methods are used in alternative embodiments of the inventions. Such methods include PAS-MRI as described in Jansons, K. M. and D. C. Alexander: “Persistent angular structure: new insights from diffusion magnetic resonance imaging data” Inverse Problems 19, pp 1031-1046; and Parker, G. J. M. and D. C. Alexander: “Probabilistic anatomical connectivity derived from the microscopic persistent angular structure of cerebral tissue” Philosophical Transactions of the Royal Society Series B 360, pp 893-902, diffusion tensor MRI as described in Basser, P. J., J. Mattiello, et al.: “Estimation of the effective self-diffusion tensor from the NMR spin echo.” Journal of Magnetic Resonance 103, pp 247-254, tensor mixture models as described in Tuch, D. S., T. G. Reese, et al.: “High angular resolution diffusion imaging reveals intravoxel white matter fiber heterogeneity” Magnetic Resonance in Medicine 48, pp 577-582; and Parker, G. J. M. and D. C. Alexander: “Probabilistic Monte Carlo based mapping of cerebral connections utilising whole-brain crossing fibre information” Lecture Notes in Computer Science 2732, pp 684-695, ‘ball-and-stick’ models as described in Behrens, T. E. J., M. W. Woolrich, et al.: “Characterization and propagation of uncertainty in diffusion-weighted MR imaging” Magnetic Resonance in Medicine 50(5), pp 1077-1088, or spherical deconvolution methods as described in Tournier, J.-D., F. Calamante, et al.: “Direct estimation of the fiber orientation density function from diffusion-weighted MRI data using spherical deconvolution” NeuroImage 23, pp 1176-1185.

In some cases the PDF for each voxel may become single-valued. In such a case each streamline generated from a given voxel is identical and only a single streamline is therefore required to be generated.

In an alternative embodiments the PDF for each voxel may describe multiple discrete fibre orientations rather than a continuum of possible orientations.

It should also be noted that while the generation of probability density functions has been described above based upon data transformed using a Funk-Radon transform, it will be appreciated that in other embodiments of the invention a Funk-Radon transform need not be used.

Although preferred embodiments of the present invention have been described above, it will be appreciated that various modifications can be made thereto without departing from the spirit and scope of the present invention, as defined by the appended claims.

1-31. (canceled)

32. A method for generating data indicating a degree of connectivity for each of a plurality of image elements, each image element representing a part of a body to be imaged, the method comprising:
for each of a plurality of image elements, generating a data set indicating connections between that image element and others of said plurality of image elements; and
for each of said plurality of image elements, generating data indicating a degree of connectivity of that image element, said degree of connectivity being based upon said plurality of generated data sets.

33. A method according to claim 32, wherein each of said data sets represents a linear connection between one of said image elements and a plurality of other image elements.

34. A method according to claim 32, further comprising:
for each of said plurality of image elements, generating a plurality of data sets, each of said plurality of data sets being a data set indicating connections between that image element and others of said plurality of image elements.

35. A method according to claim 34, wherein each image element has associated data indicating a plurality of possible connections for that image element, and said plurality of data sets are based upon said data.

36. A method according to claim 35, wherein said associated data is a probability density function indicating probabilities of said possible connections.

37. A method according to claim 36, wherein each of said image elements are defined using data indicative of an orientation of diffusion within said body at a point represented by that image element, the method further comprising deriving said probability density functions for each of said image elements based upon data indicative of said orientation of diffusion.

38. A method according to claim 32, wherein each of said image elements are defined using data indicative of an orientation of diffusion within said body at a point represented by that image element.

39. A method according to claim 32, wherein generating data indicating a degree of connectivity of a image element comprises determining a number of data sets in which said image element is included.

40. A method according to claim 32, wherein each image element is rendered using a value based upon said data indicating a degree of connectivity relative to other image elements.

41. A method according to claim 40, wherein said body is selected from the group consisting of a human or animal body, a part of a human or animal body, a human and animal brain or a part of a human or animal brain, the method further comprising comparing said image data with reference data to generate data indicating characteristics of said body.

42. A method according to claim 41, wherein said reference data is indicative of a clinically normal state of said body, and said comparison generates data indicating whether said body is in a normal or diseased state.

43. A method according to claim 40, wherein said body is selected from the group consisting of a human or animal body, a part of a human or animal body, a human and animal brain or a part of a human or animal brain, the method further comprising comparing said image data with further data generated from said body at an earlier time.

44. A method according to claim 32, wherein said body is selected from the group consisting of a human or animal body, a part of a human or animal body, a human and animal brain or a part of a human or animal brain.

45. A method according to claim 32, wherein said image data is magnetic resonance image data.

46. A method according to claim 32, wherein each image element is a voxel.

47. A carrier medium carrying computer readable program code configured to cause a computer to carry out a method according to claim 32.

48. A computer apparatus for generating data indicating a degree of connectivity for each of a plurality of image elements, each image element representing a part of a body to be imaged, the apparatus comprising:
a memory storing processor readable instructions; and
a processor configured to read and execute instructions stored in said memory;
wherein said processor readable instructions comprise instructions controlling said processor to carry out a method according to claim 32.

49. A method for generating data indicating likelihood of diffusion in each of a plurality of directions at an image element of an image representing a part of a body being imaged, the method comprising:
generating a plurality of estimates of each of said plurality of directions of diffusion from said image data; and
generating said data indicating likelihood of diffusion in each of said plurality of directions based upon said plurality of estimates.

50. A method according to claim 49, wherein generating one of said plurality of estimates for each of said plurality of directions of diffusion comprises sampling an orientation distribution function at each of a plurality of points.

51. A method according to claim 50, wherein some of said plurality of estimates for each of said plurality of directions are determined by:
generating a set comprising a plurality of points;
processing said set of points with reference to a further set of points to generate difference data; and
generating a new set of points based upon said difference data.
